(19) United States
(12) Patent Application Publication
(10) Pub. No.: US 2009/0235040 A1
(43) Pub. Date: Sep. 17, 2009

(54) PROGRAMMBLE MEMORY APPRATUS, SYSTEMS, AND METHODS

(76) Inventors: Ajaya K. Chilumula, San Jose, CA (US); Thomas Voshell, Boise, ID (US)

Correspondence Address: Treyz Law Group, 870 Market Street, Suite 984, San Francisco, CA, 94102, US

(21) Appl. No.: 12/049,048

(22) Filed: Mar. 14, 2008

(51) Int. Cl. G06F 12/02

(52) U.S. Cl. 711/170; 711/E12.002

(57) ABSTRACT

Some embodiments include apparatus, systems, and methods having storage units coupled in parallel between a first line and a second line and a comparator circuit coupled to the second line. The first line may be configured to provide different voltages. The comparator circuit may be configured to compare a first current on the second line with a second current to provide an output signal.

### BACKGROUND

Many electronic devices often include a programmable memory component to store information about the device such as device identification (ID) and device configurations. Some conventional programmable memory components may store information in memory elements and use circuit latches to provide the stored information when the memory elements are read. In some of these programmable memory components, each memory element may have its own circuit latch. A conventional programmable memory component with a large number of memory elements and circuit latches may have a greater size or a lower storage density for a given area.

### BRIEF DESCRIPTION OF THE DRAWINGS

FIG. 1 shows a block diagram of a device according to an embodiment of the invention.

FIG. 2 shows a partial schematic diagram of a device including a programmable memory according to an embodiment of the invention.

FIG. 3 shows a partial schematic diagram of a device including a programmable memory with storage units and antifuses according to an embodiment of the invention.

FIG. 4 is an example timing diagram for the device of FIG. 3 during a write operation and a read operation.

FIG. 5 shows a schematic diagram of a signal generator according to an embodiment of the invention.

FIG. 6 shows a system according to an embodiment of the invention.

### DETAILED DESCRIPTION

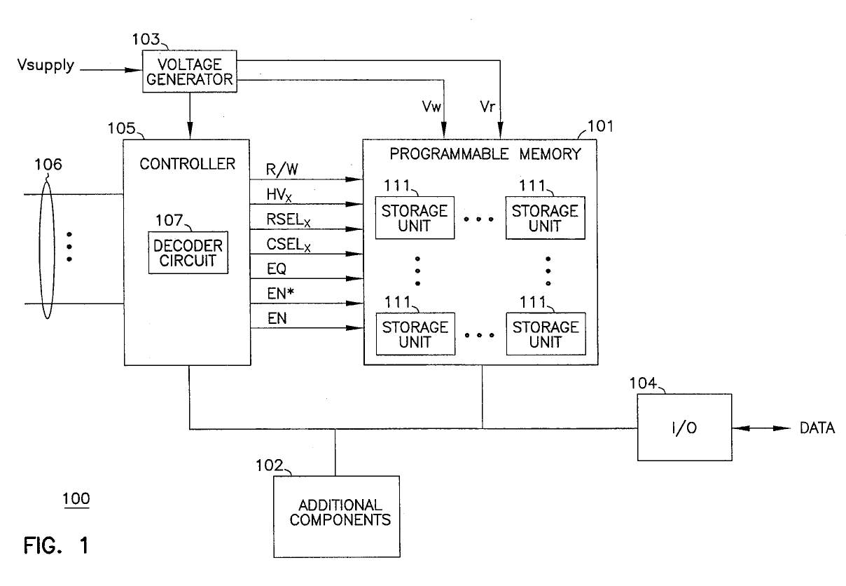

FIG. 1 shows a block diagram of a device 100 according to an embodiment of the invention. Device 100 may include an image sensor device. Device 100 may also include a memory device such as a volatile memory device, a non-volatile memory device, or a combination of both. For example, device 100 may include a dynamic random access memory (DRAM) device, a static random access memory (SRAM) device, a flash memory device, a phase change memory device, or a combination of these memory devices. Device 100 may include other electronic devices.

As shown in FIG. 1, device 100 may include a programmable memory 101 having storage units 111 to store information such as device identification (ID), manufacturer ID, device operation and configuration codes, device security codes, and other information. Storage units 111 may be written (sometimes called programmed) multiple times or only one time. Programmable memory 101 may be called one-time-programmable memory when storage units 111 are configured to have information written into them only one time.

Device 100 may include additional components 102, which may include a pixel array for use in sensing light for image processing, an array of memory cells for use as a main storage component of device 100, or both pixel array and memory cells. For example, when device 100 includes an image sensor device, additional components 102 may include a complementary metal-oxide-semiconductor (CMOS) pixel array or a charge-coupled device (CCD) pixel array. In another example, when device 100 includes a memory device, additional components 102 may include DRAM cells, SRAM cells, flash memory cells, phase change memory cells, or other types of memory cells. FIG. 1 shows programmable memory 101 and additional components 102 being located in different areas of device 100. However, programmable memory 101 and additional components 102 may be located in the same area of device 100.

Device 100 may also include a voltage generator 103 to receive a supply voltage Vsupply and generate different voltages for use in device 100, such as a voltage Vw and a voltage Vr used by programmable memory 101. Device 100 may include an input/output (I/O) circuit 104 to transfer data and information (represented by signals DATA) between device 100 and other devices external to device 100. Device 100 may include a controller 105 to control operations of device 100, such as write and read operations.

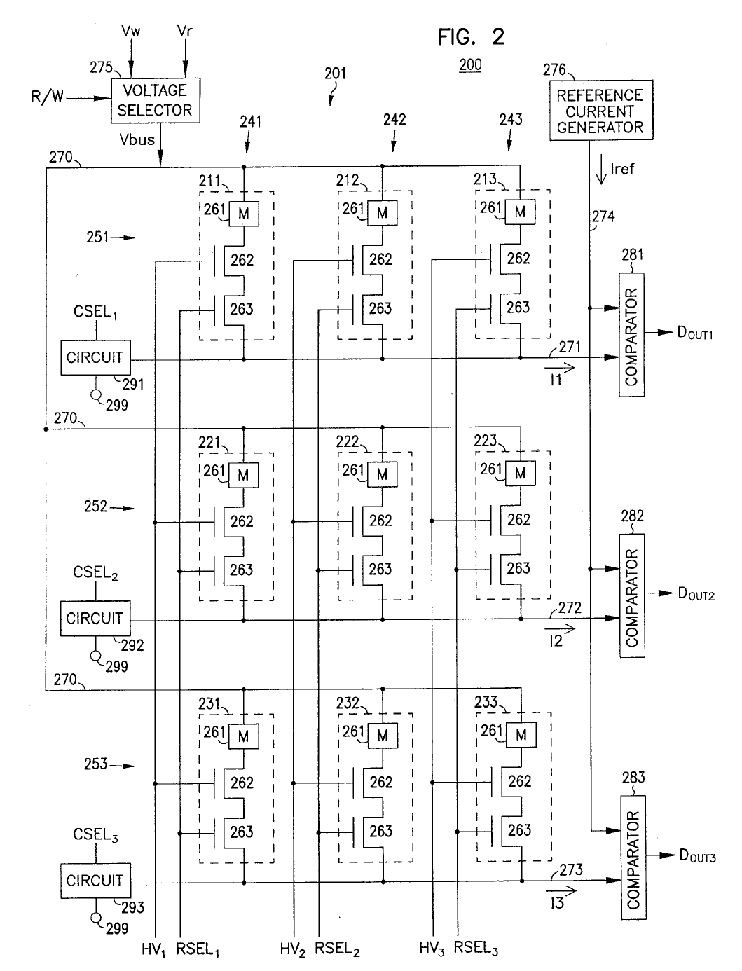

Device 100 may receive a write command in form of signals (e.g., write signals) on lines 106 to perform a write operation to selectively write information into storage units 111. Device 100 may receive a read command in form of signals (e.g., read signals) on lines 106 to perform a read operation to selectively read information from storage units 111. Controller 105 may include a decoder circuit 107 to decode signals (e.g., address signals) on lines 106 to allow device 100 to determine which one or more of storage units 111 are to be selected during a write or read operation. Controller 105 may provide control signals such as R/W, HV_{X}, RSEL_{X}, CSEL_{X}, EQ, EN*, and EN to programmable memory 101, which may use these control signals during a write or read operation of device 100. The functions of these signals may be similar to or identical to the signals described below with reference to FIG. 2 through FIG. 5.

Device 100 of FIG. 1 may have other write and read operations to access additional components 102 if information or data is to be written into or read from components (e.g., memory cells) within additional components 102. The write and read operations associated with additional components 102 may be different from the write and read operations associated with programmable memory 101.

Device 100 may include the devices (e.g., device 200 and 300) described below with reference to FIG. 2 through FIG. 6.

FIG. 2 shows a partial schematic diagram of a device 200 including a programmable memory 201 according to an embodiment of the invention. Programmable memory 201 may include storage units 211, 212, 213, 221, 222, 223, 231, 232, and 233 arranged in rows 241, 242, 243 and columns 251, 252, and 253. Each of these storage units may include a memory element (M) 261 and transistors 262 and 263. FIG. 2 shows three rows, three columns, and three storage units in each row or column as an example. The number of rows, columns, and storage units may vary. This description uses the terms row and column only for ease identifying general locations of storage units 211, 212, 213, 221, 222, 223, 231, 232, and 233. The terms row and column may be exchanged. Besides the components shown in FIG. 2, device 200 may include other components similar to or identical to those of device 100. FIG. 2 omits the other components to help focus on the embodiments described herein.

As shown in FIG. 2, the storage units in the same column may be coupled in parallel between line 270 and one of lines 271, 272, and 273. For example, storage units 211, 212, 213 in column 251 may be coupled in parallel between lines 270 and 271. Storage units 221, 222, 233 in column 252 may be coupled in parallel between lines 270 and 272. Storage units 231, 232, 233 in column 253 may be coupled in parallel between lines 270 and 273.

Device 200 may receive a write command to perform a write operation to selectively write information into storage units 211, 212, 213, 221, 222, 223, 231, 232, and 233. Device 200 may write information in parallel (concurrently) or sequentially (one at a time) into any number of selected storage units or all of storage units 211, 212, 213, 221, 222, 223, 231, 232, and 233. Device 200 may receive a read command to perform a read operation to selectively read information from these storage units. Device 200 may read information in parallel or sequentially from selected storage units of storage units in the same row or in different rows. Device 200 may read information sequentially (not in parallel) from selected storage units of storage units in the same column.

A signal R/W may include different signal levels based on the write and read commands to indicate which one of the write and read operations device 200 performs. For example, the R/W signal may have a high signal level when device 200 performs a write operation and a low signal level when device 200 performs a read operation.

Programmable memory 201 may include a voltage selector 275, which may respond to the R/W signal to selectively provide a voltage Vw and a voltage Vr to line 270 as a voltage Vbus, depending on which one of the write and read operations device 200 performs. For example, voltage Vbus may correspond to voltage Vw during a write operation and to voltage Vr during a read operation. Voltage Vw may have a value greater than the value of voltage Vr. In some cases, voltage Vw may have a value of approximately three to five times the value of voltage Vr. For example, voltage Vw may have a value of approximately seven to ten volts and voltage Vr may have a value of approximately two to three volts. Since voltage Vw may have a value higher than that of voltage Vr, and since voltage Vbus may correspond to either voltage Vw (e.g., during a write operation) or voltage Vr (e.g., during a read operation), voltage Vbus may have a value that is relatively higher during a write operation than its value during a read operation. The relatively higher value of voltage Vbus during a write operation may be used to write information into storage units 211, 212, 213, 221, 222, 223, 231, 232, and 233.

Programmable memory 201 may include comparator circuits 281, 282, and 283 to generate output signals D_{OUT1}, D_{OUT2}, and D_{OUT3}, respectively. The D_{OUT1} signal may have a value to represent the value of information read from storage unit 211, 212, or 213, depending on which storage unit among storage units 211, 212, and 213 is selected. The value of the D_{OUT1} signal may depend on a result of a comparison between a current I1 on line 271 and a current Iref on line 274. The D_{OUT2} signal may have a value to represent the value of information read from storage unit 221, 222, or 223, depending on which storage unit among storage units 221, 222, and 223 is selected. The value of the D_{OUT2} signal may depend on a result of a comparison between a current I2 on line 272 and current Iref on line 274. The D_{OUT3} signal may have a value to represent the value of information read from storage unit 231, 232, or 233, depending on which storage unit among storage units 231, 232, and 233 is selected. The value of the D_{OUT3} signal may depend on a result of a comparison between a current I3 on line 273 and current Iref on line 274. Comparator circuits 281, 282, and 283 may generate the D_{OUT1}, D_{OUT2}, and D_{OUT3} signals in parallel when storage units from different columns (one storage unit from a different column) are read in parallel. For example, comparator circuits 281, 282, and 283 may generate the D_{OUT1}, D_{OUT2}, and D_{OUT3} signals in parallel to represent information that is read in parallel from storage units 211, 221, and 231.

Programmable memory 201 may include a reference generator 276 to generate current Iref, which may have a value that is substantially stable over operating voltage and temperature of device 200. Reference generator 276 may include a bandgap current reference generator to generate current Iref. Device 200 may set current Iref at a value (e.g., a fixed value) so that comparator circuits 281, 282, and 283 may provide corresponding signals D_{OUT1}, D_{OUT2}, and D_{OUT3} with values based on values of currents 11, 12, and 13, respectively.

Each of currents 11, 12, and 13 may have a value based on information read from a selected storage unit in columns 251, 252, and 253, respectively. As shown in FIG. 2, storage units 211, 212, and 213 may be coupled to the same line 271 that carries current I1. Current I1 may have a value based on the value of information read from a selected storage unit among storage units 211, 212, and 213. Device 200 may select storage units 211, 212, and 213 one at a time to read information from the selected storage unit to provide current I1 based the value of the information. For example, during a read operation, if storage unit 211 is selected (storage units 212 and 213 are not selected), then current I1 may have a value based on the value of information read from storage unit 211. In another example, if storage unit 213 is selected (storage units 211 and 212 are not selected), then current I1 may have a value based on the value of information read from storage unit 213. Storage units 211, 212, and 213 may store information having different values. Thus, during a read operation, current I1 may have different values. Similarly to current I1, current 12 on line 272 may have a value based on the value of information read from a selected storage unit among storage units 221, 222, and 223. Current I3 on line may have a value based on the value of information read from a selected storage unit among storage units 231, 232, and 233.

Programmable memory 201 may include circuits 291, 292, and 293 to control lines 271, 272, and 273, respectively, during write and read operations. During a write operation, circuit 291 may couple line 271 to a node 299 when information is written into one or more of storage units 211, 212, and 213. Node 299 may have a voltage equal to, or substantially equal to, 0 volts. For example, node 299 may include a ground potential. During a read operation, circuit 291 may decouple line 271 from node 299 when information is read from one or more of storage units 211, 212, and 213. When it is decoupled from node 299, line 271 may “float,” e.g., be unconnected to a supply node, such as ground, of device 200. Each of circuits 292 and 293 may operate in a similar fashion to the operation of circuit 291. For example, during a write operation, circuit 292 may couple line 272 to node 299 when device 200 selects to write information into one or more of storage units 221, 222, and 223. During a read operation, circuit 292 may decouple line 272 from node 299 when device 200 selects to read information from one or more of storage units 221, 222, and 223. Circuit 293 may couple line 273 to node 299 when device 200 selects to write information into one or more of storage units 231, 232, and 233. Circuit 293 may decouple line 273 from node 299 when device 200 selects to read information from one or more of storage units 231, 232, and 233.

Device 200 may use signals HV₁, RSEL₁, HV₂, RSEL₂, HV₃, and RSEL₃ to selectively turn on transistors 262 and 263 of storage units 211, 212, 213, 221, 222, 223, 231, 232, and 233 to select one or more of these storage units. Device 200 may use signals CSEL₁, CSEL₂, and CSEL₃ to allow circuits 291, 292, and 293, respectively, to either couple corresponding lines 271, 272, and 273 to node 299 or decouple corresponding lines 271, 272, and 273 from node 299. Device 200 may include a controller (omitted from FIG. 2 but similar to or identical to controller 105 of FIG. 1) to provide the signals HV₁, RSEL₁, HV₂, RSEL₂, HV₃, RSEL₃, CSEL₁, CSEL₂, and CSEL₃. FIG. 2 shows signals HV₁, HV₂, and HV₃ being three different signals such that device 200 may control them differently. For example, device 200 may activate one or more of these signals (e.g., when one or more storage units in one or more corresponding rows are selected) and deactivate the rest of these signals (e.g., when storage units in one or more corresponding rows are unselected). Device 200, however, may control signals HV₁, HV₂, and HV₃ in the same manner. For example, device 200 may concurrently activate signals HV₁, HV₂, and HV₃ (e.g., when at least one of storage units 211, 212, 213, 221, 222, 223, 231, 232, and 233 is selected) and concurrently deactivate signals HV₁, HV₂, and HV₃ (e.g., when none of storage units 211, 212, 213, 221, 222, 223, 231, 232, and 233 is selected). Device 200 may include a decoder circuit (omitted from FIG. 2 but similar to or identical to decoder circuit 107 of FIG. 1) to determine which one of the signals HV₁, RSEL₁, HV₂, RSEL₂, HV₃, RSEL₃, CSEL₁, CSEL₂, and CSEL₃ to use to select storage units 211, 212, 213, 221, 222, 223, 231, 232, and 233.

For example, to select storage unit 211, device 200 may use signals HV₁ and RSEL₁ to turn on transistors 262 and 263 in row 241. In this example, device 200 may use signal CSEL₁ to allow circuit 291 to either couple line 271 (being associated with the selected storage unit 211 in this example) to node 299 if device 200 selects to write information into storage unit 211 or decouple line 271 from node 299 if device 200 selects to read information from storage unit 211. In another example, to select storage unit 222, device 200 may use signals HV₂ and RSEL₂ to turn on transistors 262 and 263 in row 242. In this example, device 200 may use signal CSEL₂ to allow circuit 292 to either couple line 272 (being associated with the selected storage unit 222 in this example) to node 299 if device 200 selects to write information into storage unit 222 or decouple line 271 from node 299 if device 200 selects to read information from storage unit 222.

Device 200 may use signals HV₁, RSEL₁, HV₂, RSEL₂, HV₃, RSEL₃, CSEL₁, CSEL₂, and CSEL₃ to select multiple storage units 211, 212, 213, 221, 222, 223, 231, 232, and 233 to write information in parallel into the multiple selected storage units, or to read information in parallel from the multiple selected storage units from multiple columns in parallel. Device 200 may write information in parallel into multiple selected storage units in different columns (one storage unit from a different column) or in the same column. The multiple selected storage units may come from the same row or from different rows. Device 200 may also write information in parallel into multiple entire columns. Device 200 may also write information sequentially into one entire column and then write information into the next entire column. Device 200 may read information in parallel from selected storage units from columns (one storage unit from a different column). The multiple selected storage units may come from the same row or from different rows. Device 200 may also read information sequentially from one entire row to the next entire row. Writing information into or reading information from storage units 211, 212, 213, 221, 222, 223, 231, 232, and 233 in parallel may reduce write or read time, improve device performance, or both.

Each of storage units 211, 212, 213, 221, 222, 223, 231, 232, and 233 may include different states to represent different values (e.g., binary values 0 and 1) of information to be stored therein. Each of these storage units may change from one state to another state (among the different states), depending on which value of the information is to be stored therein. Device 200 may perform a write operation to cause one or more selected storage unit of storage units 211, 212, 213, 221, 222, 223, 231, 232, and 233 to change from one state to another state. For example, as described above, during a write operation, device 200 may apply voltage Vbus with a value corresponding to the value of voltage Vw and use circuits 291, 292, and 293 to couple one or more of lines 271, 272, and 273 to node 299. The voltage difference between lines 270 and node 299 may cause the selected storage unit (or storage units) to change from one state to another state. Device 200 may allow a selected storage unit to remain at its state (e.g., the state before a write operation) if the value of the information to be stored in the selected storage unit corresponds to the state that the selected storage unit may already have. For example, if a selected storage unit has an open state and the value of the information to be stored into the selected storage unit also corresponds to the open state, then the controller of device 200 may direct device 200 to skip performing the write operation. Thus, in this example, device 200 does not perform the write operation.

Each memory element 261 of storage units 211, 212, 213, 221, 222, 223, 231, 232, and 233 may include programmable memory elements such as antifuse, fuse, or other types of memory elements.

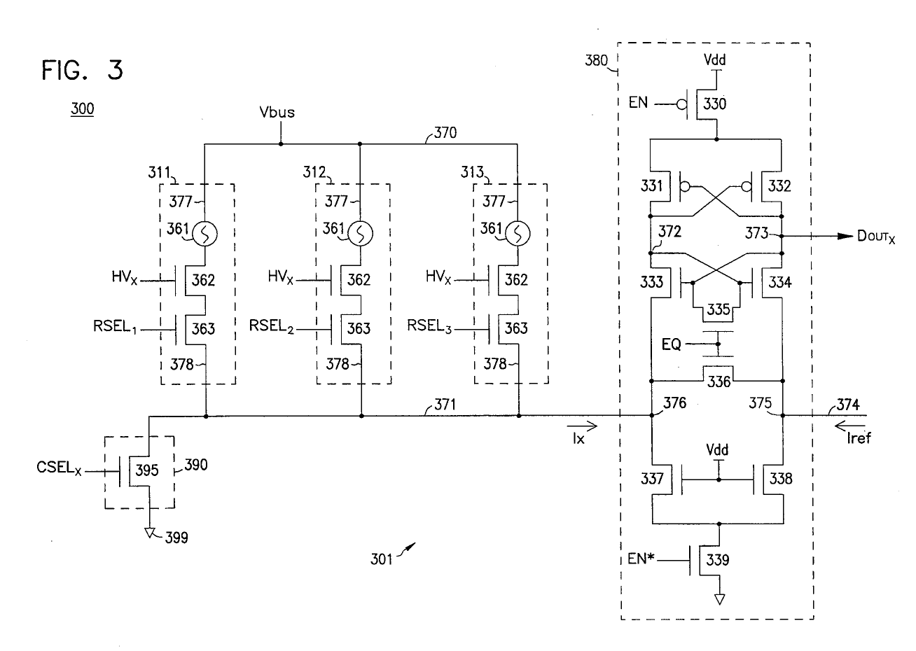

FIG. 3 shows a partial schematic diagram of a device 300 having a programmable memory 301 with storage units 311, 312, and 313 and antifuses 361 according to an embodiment of the invention. Each of storage units 311, 312, and 313 may also include nodes 377 and 378 (shown as lines in FIG. 3), and transistors 362 and 363 coupled in series with antifuse 361 between nodes 377 and 378. Device may include line 370 to provide a voltage Vbus to each node 377, and a line 371 coupled to each node 378 to carry a current Ix. Device 300 may also include a current sensing circuit 380 to receive current Ix and a current Iref to generate a signal D_{OUTx} during a read operation.

Device 300 may use signals HV_{X}, RSEL₁, RSEL₂, and RSEL₃ to selectively turn on transistors 362 and 363 to select one or more of storage units 311, 312, and 313 during a write or read operation. Device 300 may include a circuit 390 having a transistor 395, which may respond a signal CSEL_{X} to couple line 371 to node 399 during the write operation or decouple line 371 from node 399 during the read operation. In a write operation, voltage Vbus may have a value that is higher than its value during a read operation. Transistor 362 may have a structure to withstand the relatively high value of voltage Vbus during a write operation to protect transistor 363 from damage.

Voltage Vbus may correspond to voltage Vbus of FIG. 2. Current Ix of FIG. 3 may correspond to one of currents 11, 12, and 13 of FIG. 2. Signal D_{OUTx} of FIG. 3 may correspond to signal D_{OUT1}, D_{OUT2}, or D_{OUT3} of FIG. 3. Signal CSEL_{X} of FIG. 3 may correspond to signal CSEL₁, CSEL₂, or CSEL₃ of FIG. 2. Signals HV_{X} of FIG. 3 may correspond to signal HV₁, HV₂, or HV₃ of FIG. 2. Signals RSEL₁, RSEL₂, and RSEL₃ of FIG. 3 may correspond to signals RSEL₁, RSEL₂, and RSEL₃ of FIG. 2. Besides the components shown in FIG. 3, device 300 may include other components similar to or identical to those of device 100 of FIG. 1 and device 200 of FIG. 2. FIG. 3 omits the other components to help focus on the embodiments described herein.

Each of storage units 311, 312, and 313 may include different states based on the state of antifuse 361. An antifuse, such as antifuse 361, usually has two different states: a state when the antifuse is open (or “unfused”) and a state when the antifuse is closed (or “fused”). The antifuse normally has an open state to prevent conduction of current through it. The antifuse may allow conduction of current through it when it has a closed state. The antifuse often has a non-conductive material (e.g., an oxide of silicon or nitrogen) placed between its conductive terminals to electrically isolate the conductive terminals to allow the antifuse to normally (e.g., initially) have an open state. A write operation, such as the write operation described above, may change the state of the antifuse from the open state to the closed state by applying a high voltage between conductive terminals of the antifuse to modify the structure of the antifuse and create a conductive path through the non-conductive material to electrically connect (e.g., short-circuit) the conductive terminals.

In FIG. 3, antifuse 361 of each of storage units 311, 312, and 313 may initially have an open state. In a write operation, device 300 may cause antifuse 361 of the selected storage unit to change from an open state (e.g., initial state) to the closed state if the information to be stored in the selected storage unit has a value corresponding to the closed state. If information to be stored in the selected storage unit has a value corresponding to the open state, device 300 may allow antifuse 361 of the selected storage unit to remain at the initial open state. Thus, the state of antifuse 361 of the selected storage unit may remain unchanged, depending on the information to be stored in the selected storage unit. Changing between states in each antifuse 361 may be irreversible. Thus, antifuse 361 may change from the one state (e.g., open state) to another state (e.g., the closed state) only one time.

In a write operation, device 300 may select one or more of storage units 311, 312, and 312 by turning on transistors 362 and 363 of the selected storage unit. Device 300 may turn off transistors 362 and 363 of the unselected storage unit (or storage units). For example, if device 300 selects to change the state of antifuse 361 of storage unit 311, device 300 may use signals HV_{X} and RSEL₁ to turn on transistors 362 and 363 of storage unit 311, and use signals RSEL₂ and RSEL₃ to turn off (or keep off) transistors 362 and 363 of storage units 312 and 313. Then, device 300 may apply a relatively higher value for voltage Vbus (e.g., the value of Vw of FIG. 2), and turn on transistor 395 to couple line 371 to node 399. The voltage difference between nodes 377 and node 378 across antifuse 361 of storage unit 311 (or between nodes 377 and 399) may have a relatively high value to cause antifuse 361 of storage unit 311 to change from an open state to a closed state. Device 300 may write information into the selected storage unit by performing a write operation to cause antifuse 361 of the selected storage unit to change from one state (e.g., open state) to another state (e.g., closed state). Device 300 may skip performing a write operation and allow antifuse 361 of the selected storage unit to remain at an initial state (e.g., open state) if the value of the information to be stored into the selected storage unit corresponds to the state (e.g., the state before a write operation) of antifuse 361 of the selected storage unit. Device 300 may write information in parallel into multiple selected storage units (e.g., two or all three) of storage units 311, 312, and 312.

In a read operation, device 300 may select one of storage units 311, 312, and 313 to read information from the selected storage unit by turning on transistors 362 and 363 of the selected storage unit. Device 300 may turn off transistors 362 and 363 of the unselected storage unit (or storage units). For example, if device 300 selects to read storage unit 311, device 300 may use signals HV_{X} and RSEL₁ to turn on transistors 362 and 363 of storage unit 311, and use signals RSEL₂ and RSEL₃ to turn off (or keep off) transistors 362 and 363 of storage units 312 and 313. Then, device 300 may apply a relatively lower value for voltage Vbus (e.g., the value of Vr of FIG. 2), and turn off transistor 395 to decouple line 371 from node 399. Depending on the state of antifuse 361 of storage unit 311 (the selected storage unit in this example), current Ix may have different values. Current Ix may have a relatively lower value when antifuse 361 has an open state than when antifuse 361 has a closed state. For example, current Ix may have a value equal to or substantially equal to zero when antifuse 361 has an open state, and a value equal to some positive value when antifuse 361 has an open state.

Current sensing circuit 380 may receive current Ix during a read operation and compare it with current Iref to generate signal D_{OUTx}. Current sensing circuit 380 may include nodes 375 and 376, nodes 372 and 373, and transistors 330, 331, 332, 333, 334, 335, 336, 337, 338, and 339 coupled in ways shown in FIG. 3. For example, transistors 337 and 338 may include non-gate terminals coupled to input nodes 375 and 376 to receive currents Iref and Ix from lines 374 and 371, respectively. The gates (gate terminals) of transistors 337 and 338 may be coupled to a voltage Vdd, which may include a supply voltage of device 300. In the description herein, a non-gate terminal of a transistor refers to a terminal that is not a gate of a transistor. For example, a transistor (e.g., p-channel or n-channel transistor) may include a gate (gate terminal), a source terminal, and a drain terminal, in which case the non-gate terminals of the transistor are the source and drain terminals of the transistor.

As shown in FIG. 3, transistors 330 and 339 may respond to signal EN and EN*, respectively, to activate current sensing circuit 380 in a read operation. Transistors 335 and 336 may respond to a signal EQ to electrically couple nodes 372, 373, 375, and 376 to each other to stabilize current sensing circuit 380 before it generates the D_{OUTx} signal. Nodes 375 and 376 may be called input nodes of current sensing circuit 380. Node 373 may be called an output node of current sensing circuit 380.

The D_{OUTx} signal may have one value (e.g., a value corresponding to binary value 1) when the value of current Ix is less than the value of current Iref (e.g., when antifuse 361 of a selected storage unit has an open state). The D_{OUTx} signal may have another value (e.g., a value corresponding to binary value 0) when the value of current Ix is greater than the value of current Iref (e.g., when antifuse 361 of a selected storage unit has a closed state).

As show in FIG. 3 and as described above, using the same circuit component (e.g., the same current sensing circuit 380) for multiple storage units 311, 312, and 313 to receive current Ix during reading of information from these storage units allows device 300 to have reduced components. Reduced components allows device 300 to have a relatively reduced size for programmable memory 301, or a relatively higher density for the storage units for a given area, or both.

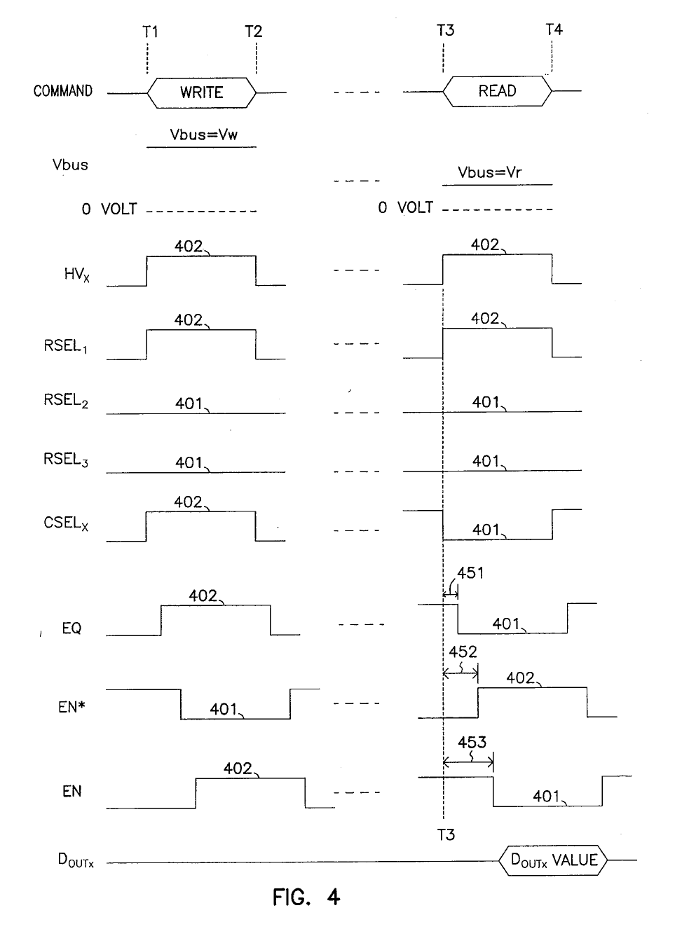

The following description refers to both FIG. 3 and FIG. 4.

FIG. 4 is an example timing diagram for device 300 of FIG. 3 during a write operation and a read operation. As shown in FIG. 4, device 300 may perform write operation between times T1 and T2 in response to a command (e.g., a command WRITE), and a read operation between times T3 and T4 in response to a command (e.g., a command READ). The time diagram of FIG. 4 assumes storage unit 311 is the selected storage unit for both the write and read operations. As shown in FIG. 4, the RSEL, signal has a signal value 402 (e.g., high signal level) to turn on transistor 363 of storage unit 311, and the signals RSEL₂ and RSEL₃ have signal value 401 (e.g., low signal level) to turn off transistors 363 of storage units 312 and 313 (unselected storage units). The HV_{X} signal has signal value 402 to turn on transistor 362 of each of storage units 311, 312, and 313. Although transistors 362 of all storage units 311, 312, and 313 are turned on, storage units 312 and 313 are unselected storage units because transistors 363 of these two storage units are turned off.

As shown in FIG. 4, voltage Vbus has different voltage values, such as a value corresponding to the value of voltage Vw during the write operation, and a value corresponding to the value of voltage Vr during the read operation. The CSEL_{X} signal may have either signal value 401 or 402, depending on which one of the write and read operations that device 300 performs. For example, in the write operation, the CSEL_{X} signal has signal value 402 to turn on transistor 395 to couple line 371 to node 399. In the read operation, the CSEL_{X} signal has a signal value 401 turn off transistor 395 to decouple line 371 from node 399.

In the write operation, the EQ and EN signals have signal value 402, and the EN* signal has signal value 401 to deactivate current sensing circuit 380. In the read operation, these EQ, EN*, EN signals may change their signal values (e.g., signal values opposite from those during the write operation) to activate current sensing circuit 380. For example, during the read operation, the EQ signal has signal value 402 before time T3 to turn on transistors 335 and 336 to electrically couple nodes 372, 373, 375, and 376 to each other. Then, after the CSEL_{X} signal may change from signal value 402 to signal value 401 at time T3, the EQ signal may change from signal value 402 to signal value 401 after a time delay 451 from time T3 to turn off transistors 335 and 336 to electrically decouple nodes 372, 373, 375, and 376 from each other in preparation for the D_{OUTx} signal to be generated. After nodes 372, 373, 375, and 376 are electrically decoupled from each other, the EN* and EN signals may change to signal values 402 and 401, respectively. As shown in FIG. 4, the EN* signal changes to signal value 402 after a time delay 452 from time T3, and the EN signal changes to signal value 401 after a time delay 453 from time T3. After the EN signal changes to signal value 401, current sensing circuit 380 may generate the D_{OUTx} signal with a value (shown as D_{OUTx} VALUE in FIG. 4) based on the result of the comparison between current Ix and current Iref.

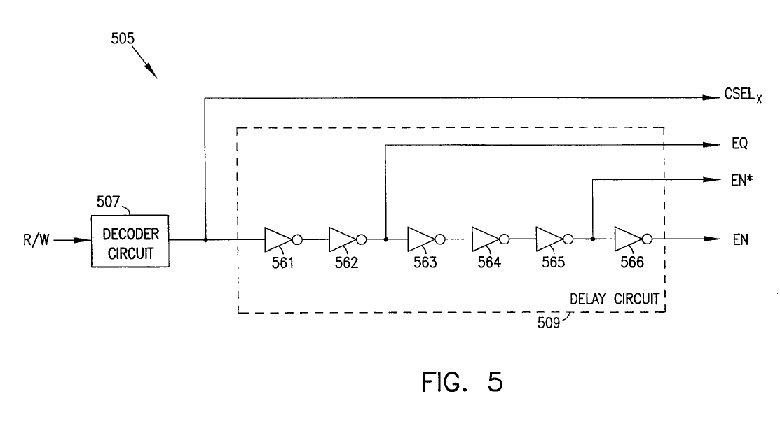

Device 300 may include a signal generator, such as the signal generator of FIG. 5, to generate signals CSEL_{X}, EQ, EN*, EN shown in FIG. 3 and FIG. 4.

FIG. 5 shows a schematic diagram of a signal generator 505 according to an embodiment of the invention. Signal generator 505 may be included in a device such as device 300 of FIG. 3 to generate control signals such as signals CSEL_{X}, EQ, EN*, and EN. Signal generator 505 may include a decoder circuit 507, which may respond to a signal R/W. The R/W signal may be similar to or identical to the R/W signal of FIG. 2. Signal generator 505 of FIG. 5 may be included in a device (e.g., device 300 of FIG. 3) in which the R/W signal may include different signal levels based on write and read commands to indicate which one of the write and read operations the device performs. For example, the R/W signal may have a high signal level when the device performs a write operation and a low signal level when the device performs a read operation. Based on the signal levels of the R/W signal, decoder circuit 507 may generate signals CSEL_{X}, EQ, EN*, and EN with appropriate signal levels. For example, when the R/W signal has a high signal level, decoder circuit 507 may generate signals CSEL_{X}, EQ, EN*, and EN with signal levels similar to or identical to those of signals CSEL_{X}, EQ, EN*, and EN of FIG. 4 during the write operation. In another example, when the R/W signal of FIG. 5 has a low signal level, decoder circuit 507 may generate signals CSEL_{X}, EQ, EN*, and EN with signal levels similar to or identical to those of signals CSEL_{X}, EQ, EN*, and EN of FIG. 4 during the read operation.

As shown in FIG. 5, signals EQ, EN*, and EN may include delayed copies of the CSEL_{X} signal. For example, the EQ signal may include a first delayed copy of the CSEL_{X} signal, which is the CSEL_{X} signal delayed by two inverters 561 and 562. The EN* signal may include a second delayed copy of the CSEL_{X} signal, which is the CSEL_{X} signal delayed by five inverters 561, 562, 563, 564, and 565. The EN signal may include a third delayed copy of the CSEL_{X} signal, which is the CSEL_{X} signal delayed by six inverters 561, 562, 563, 564, 565, and 566. The time delays between the signals CSEL_{X} and EQ, between the signals CSEL_{X} and EN*, and between the signals CSEL_{X} and EN may correspond to time delays 451, 452, and 453, respectively, of FIG. 4. As described herein with reference to FIG. 5, since signal generator 505 may generate the EQ, EN*, and EN signals as delayed copies of a single signal, (e.g., the CSEL_{X} signal), circuit simplicity may be achieved.

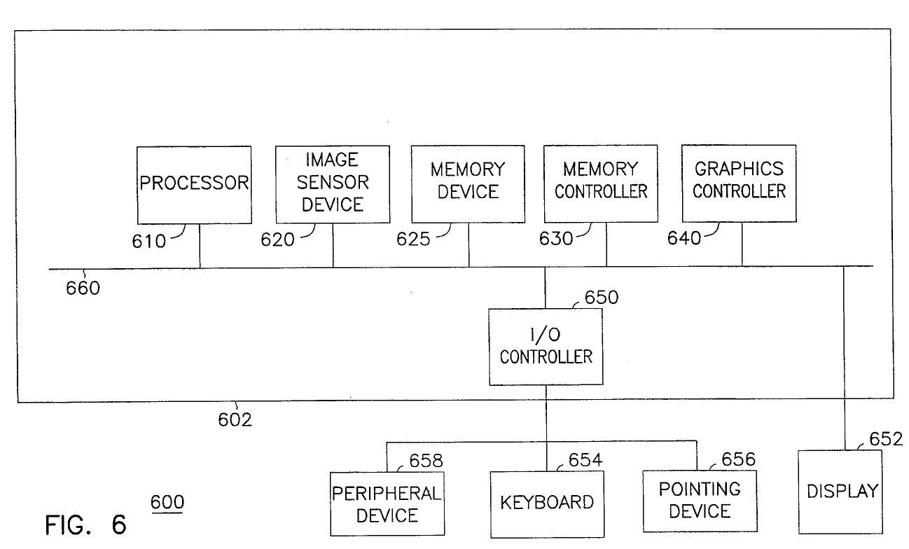

FIG. 6 shows a system 600 according to an embodiment of the invention. System 600 may include a processor 610, an image sensor device 620, a memory device 625, a memory controller 630, a graphics controller 640, I/O controller 650, a display 652, a keyboard 654, a pointing device 656, a peripheral device 658, and a bus 660 to transfer information among the components of system 600. System 600 may also include a circuit board 602 on which some components of system 600 may be located. FIG. 6 shows a specific number of components of a system as an example. The number of components of system 600 may vary. For example, system 600 may omit one or more of display 652, image sensor device 620, and memory device 625.

Processor 610 may include a general-purpose processor or an application specific integrated circuit (ASIC). Processor 610 may comprise a single core processor or a multiple-core processor. Processor 610 may execute one or more programming commands to process information. The information may include output information provided by other components of system 600, such as by image sensor device 620 or memory device 625.

Image sensor device 620 may include a CMOS image sensor having a CMOS pixel array. Image sensor device 620 may include a CCD image sensor having a CCD pixel array. Image sensor device 620 may include one or more embodiments described above with reference to FIG. 1 through FIG. 5, such as devices 100, 200, and 300 and signal generator 505.

Memory device 625 of FIG. 6 may include a volatile memory device, a non-volatile memory device, or a combination of both. For example, memory device 625 may include a DRAM device, an SRAM device, a flash memory device, or a combination of these memory devices.

Display 652 may include an analog display or a digital display. Display 652 may receive information from other components. For example, display 652 may receive information that is processed by one or more of image sensor device 620, memory device 625, graphics controller 640, and processor 610 to display information such as text or images.

The illustrations of the apparatus such as devices 100, 200, and 300 and signal generator 505 and a system such as system 600 are intended to provide a general understanding of the structure of various embodiments, and not a complete description of all the elements and features of apparatus and systems that might make use of the structures described herein.

Any of the components described above can be implemented in a number of ways, including simulation via software. Thus, apparatus (e.g., devices 100, 200, and 300 and signal generator 505) and systems (e.g., a portion of system 600 or the entire system 600) described above may all be characterized as “modules” (or “module”) herein. Such modules may include hardware circuitry, single and/or multi-processor circuits, memory circuits, software program modules and objects and/or firmware, and combinations thereof, as desired by the architect of the apparatus (e.g., devices 100, 200, and 300 and signal generator 505) and systems (e.g., system 600), and as appropriate for particular implementations of various embodiments. For example, such modules may be included in a system operation simulation package, such as a software electrical signal simulation package, a power usage and distribution simulation package, a capacitance-inductance simulation package, a power/heat dissipation simulation package, a signal transmission-reception simulation package, and/or a combination of software and hardware used to operate or simulate the operation of various potential embodiments.

The apparatus and systems (e.g., devices 100, 200, and 300 and signal generator 505 and system 600) of various embodiments may include or be included in electronic circuitry used in high-speed computers, communication and signal processing circuitry, single or multi-processor modules, single or multiple embedded processors, multi-core processors, data switches, and application-specific modules including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., MP3 (Motion Picture Experts Group, Audio Layer 3) players), vehicles, medical devices (e.g., heart monitor, blood pressure monitor, etc.), set top boxes, and others.

One or more embodiments described herein include apparatus, systems, and methods having storage units coupled in parallel between a first line and a second line, and a comparator circuit coupled to the second line. The first line may be configured to provide different voltages. The comparator circuit may be configured to compare a first current on the second line with a second current to provide an output signal. Other embodiments, including additional apparatus, systems, and methods are described above with reference to FIG. 1 through FIG. 6.

The above description and the drawings illustrate some embodiments of the invention to enable those skilled in the art to practice the embodiments of the invention. Other embodiments may incorporate structural, logical, electrical, process, and other changes. In the drawings, like features or like numerals describe substantially similar features throughout the several views. Examples merely typify possible variations. Portions and features of some embodiments may be included in, or substituted for, those of others. Many other embodiments will be apparent to those of skill in the art upon reading and understanding the above description. Therefore, the scope of various embodiments of the invention is checked by the appended claims, along with the full range of equivalents to which such claims are entitled.

The Abstract is provided to comply with 37 C.F.R. §1.72(b) requiring an abstract that will allow the reader to quickly ascertain the nature and gist of the technical disclosure. The Abstract is submitted with the understanding that it will not be used to interpret or limit the scope or meaning of the claims.

What is claimed is:

1. An apparatus comprising:
a plurality of storage units coupled in parallel between a first line and a second line, the first line configured to provide a first voltage when information is written into at least one of the plurality of storage units and to provide a second voltage when information is read from at least one of the plurality of storage units, the second line configured to carry a first current when information is read from at least one of the plurality of storage units; and
a comparator circuit configured to compare the first current on the second line with a second current on a third line to provide an output signal.

2. The apparatus of claim 1, wherein each of the plurality of storage units includes a memory element configured to have a first state to allow conduction of current through the memory element and a second state to prevent conduction of current through the memory element.

3. The apparatus of claim 2, wherein the memory element is configured to change between the first state and the second state only one time.

4. The apparatus of claim 1 further comprising a circuit configured to couple the second line to a node when information is written into at least one of the plurality of storage units, wherein the node is operatively coupled to a voltage having a value less than a value of each of the first and second voltages.

5. The apparatus of claim 1, wherein information is written in parallel into multiple storage units of the plurality of storage units when the multiple storage units are selected.

6. The apparatus of claim 1, wherein each of the first and second voltages includes a positive value.

7. The apparatus of claim 1 further comprising:
a plurality of additional storage units coupled in parallel between the first line and a fourth line, the fourth line configured to carry an additional current when information is read from at least one of the plurality of additional storage units; and
an additional comparator circuit configured to compare the additional current on the fourth line with the second current to provide an additional output signal.

8. The apparatus of claim 7, wherein the comparator circuit and the additional comparator circuit provide the output signal and the additional output signal in parallel when one of the plurality of storage units and one of the plurality of additional storage units are read.

9. An apparatus comprising:
a plurality of storage units, each including a first node, a second node, and an antifuse coupled between the first and second nodes; and
a first line configured to selectively provide a first voltage and a second voltage to the first node of each of the plurality of storage units;
a second line coupled to the second node of each of the plurality of storage units and configured to carry a first current passing through the antifuse of at least one of the plurality of storage units; and
a current sensing circuit including a first input node coupled to the second line, a second input node coupled to a third line, and an output node to provide an output signal having a value based on a value of the first current on the second line and a value of a second current on the third line.

10. The apparatus of claim 9, wherein each of the plurality of storage units includes a transistor coupled in series with the antifuse.

11. The apparatus of claim 10, wherein each of the plurality of storage units includes an additional transistor coupled between the transistor and the antifuse.

12. The apparatus of claim 11, wherein the current sensing circuit includes a first transistor having a non-gate terminal coupled to the second line to receive the first current, and a second transistor having a non-gate terminal coupled to the third line to receive the second current.

13. The apparatus of claim 9 further comprising a circuit configured to couple the second line to a ground potential when the first line provides the first voltage.

14. The apparatus of claim 13, wherein the circuit is configured to decouple the second line from the ground potential when the first line provides the second voltage.

15. The apparatus of claim 13, wherein the circuit includes a transistor configured to receive a control signal to decouple the second line from the ground potential, and wherein the current sensing circuit includes a transistor configured to receive a delayed copy of the control signal to activate the current sensing circuit.

16. The apparatus of claim 9, wherein the first voltage has a value of approximately three to five times a value of the second voltage.

17. A system comprising:
an image sensor device including:
a plurality of storage units coupled in parallel between a first line and a second line, the first line configured to provide a first voltage when information is written into at least one of the plurality of storage units and to provide a second voltage when information is read from at least one of the plurality of storage units, the second line configured to carry a first current when information is read from at least one of the plurality of storage units; and
a comparator circuit configured to compare the first current on the second line with a second current on a third line to provide an output signal; and
a processor configured to process information from the image sensor device.

18. The system of claim 17, wherein each of the plurality of storage units includes a memory element configured to have a first state to allow conduction of current through the memory element and a second state to prevent conduction of current through the memory element.

19. The system of claim 18, wherein the memory element includes an antifuse coupled between the first and second lines.

20. The system of claim 17, wherein the comparator circuit includes a current sensing circuit having a first input node coupled to the second line, a second input node coupled to a third line, and an output node to provide the output signal.

21. A method comprising:
selecting a storage unit of a plurality of storage units coupled between a first line and a second line;
applying a first voltage to the first line if information is to be written into the storage unit;
applying a second voltage to the first line if information is to be read from the storage unit; and
comparing a first current on the second line with a second current on a third line to generate an output signal if information is read from the storage unit.

22. The method of claim 21, wherein selecting the storage unit includes turning on a transistor coupled to an antifuse of the storage unit, the transistor and the antifuse being coupled in series between the first and second line.

23. The method of claim 21, wherein comparing includes:
providing the first current to a first input node of a current sensing circuit; and
providing the second current to a second input node of the current sensing circuit.

24. The method of claim 21 further comprising:
coupling the second line to a ground potential if information is to be written into the storage unit.

25. The method of claim 24 further comprising:
decoupling the second line from the ground potential if information is to be read from the storage unit.
